(19) United States
(12) Patent Application Publication
(10) Pub. No.: US 2026/0347625 A1
(43) Pub. Date: Nov. 5, 2026

(54) MARKING COMPOSITION AND PREPARATION PROCESS THEREOF

(71) Applicant: OMNISECURE PRIVATE LIMITED, Thiruvananthapuram (IN)

(72) Inventor: K Rajan Babu, Trivandrum (IN)

(21) Appl. No.: 19/418,028

(22) Filed: Dec. 12, 2025

(30) Foreign Application Priority Data
Dec. 16, 2024 (IN) 202441099537

(51) Int. Cl. C09D 5/22; C08K 9/02; C09D 5/02; C09D 7/40; C09D 7/62; C09D 133/04; C09D 175/04; C09K 11/02

(52) U.S. Cl. CPC C09D 5/22; C09D 5/022; C09D 5/028; C09D 7/62; C09D 7/69; C09D 133/04; C09D 175/04; C09K 11/025; C08K 9/02

(57) ABSTRACT

A marking composition including a phosphorescent component; a silica-based component; and a water-based medium, wherein the marking composition emits light when an ambient light surrounding the marking composition is below a pre-defined illumination, and wherein the emitted light is independent of a continuous external light source, and a preparation process thereof.

### CROSS-REFERENCE TO RELATED APPLICATIONS AND PRIORITY

The present application does claim priority from Indian Patent Application no. 202441099537 filed on Dec. 16, 2024.

### TECHNICAL FIELD

The present disclosure, in general, relates to the field of marking technology and particularly relates to a marking composition and preparation process thereof.

### BACKGROUND

Visibility markings are crucial for ensuring safety and enhancing navigation in both indoor and outdoor environments. They serve to guide individuals, manage traffic flow, and delineate spaces across various settings, including warehouses, factories, and public areas. In indoor spaces, these markings significantly contribute to accident prevention and improve operational efficiency, particularly in areas with heavy foot traffic. In outdoor environments, visibility markings play an equally vital role, helping to regulate traffic, indicate pedestrian crossings, and define boundaries. Their effective implementation not only fosters a safer environment but also facilitates smooth movement, thereby enhancing overall functionality in both public and private spaces.

For an extended period, marking systems have relied on a combination of reflective materials, including cement, fluorescent pigments, silica, glass fibers, and acrylic polymer agents for visibility marking compositions. While these traditional reflective marking components provide certain advantages, they also present notable drawbacks that impact both their effectiveness and environmental sustainability.

One significant concern is that many of these compositions exhibit limited durability and inadequate long-term luminescence. This poses challenges in practical applications where longevity and reliability are essential. Furthermore, some luminescent materials, particularly glass beads used in reflective paints, have been found to leach harmful heavy metals such as lead and arsenic. These substances often exceed permissible limits established by the United States Environmental Protection Agency (EPA), raising serious concerns about their safety and environmental impact.

Currently, phosphorescent/phosphor-based compositions have emerged as viable alternatives to traditional luminescent and reflective materials, driven by their unique properties and advantages. Primarily developed to enhance visibility and performance in marking applications, these compositions offer several key benefits, including superior luminescent properties, versatility across a wide range of applications, customization options, and increased durability.

However, commercially available phosphor-based compositions often rely on organic solvents, which can emit undesirable vapors into the atmosphere and pose significant risks of soil and water contamination, particularly in areas adjacent to roadways. Additionally, sulphide-based phosphor compositions face considerable challenges, including chemical instability and limited effectiveness in outdoor environments; thereby complicating their practical use.

As the demand for environmentally friendly materials continues to rise across various industries, there is an urgent need for sustainable marking solutions suitable for both indoor and outdoor applications. These solutions must not only meet the increasing expectations for eco-conscious alternatives but also ensure safety and maintain usability.

The current disclosure aims to address the foregoing challenges by placing innovative and efficient water-based alternatives. The compositions of the instant disclosure are specifically designed to provide prolonged afterglow periods, enhanced moisture stability, and robust protection against UV degradation. By ensuring improved visibility, these compositions aim to meet environmental safety standards and practical performance requirements to represent a significant advancement in marking technology.

### SUMMARY

Before the present composition and method and its components are summarized, it is to be understood that this disclosure is not limited to the composition and its arrangement as described, as there can be multiple possible embodiments that are not expressly illustrated in the present disclosure. The present application overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present disclosure. This summary is not intended to identify essential features of the claimed subject matter nor is it intended for use in detecting or limiting the scope of the claimed subject matter.

An embodiment of the instant disclosure relates to a marking composition, comprising a phosphorescent component; a silica-based component; and a water-based medium, wherein the marking composition emits light when an ambient light surrounding the marking composition is below a pre-defined illumination, and wherein the emitted light is independent of a continuous external light source.

Another embodiment of the instant disclosure relates to a process for preparing a marking composition, comprising synthesizing a phosphorescent component; coating the phosphorescent component using a silica-based component to obtain a coated phosphorescent component; and dispersing the coated phosphorescent component in a water-based medium to obtain the marking composition, wherein the marking composition emits light when an ambient light surrounding the marking composition is below a pre-defined illumination, and wherein the emitted light is independent of a continuous external light source.

### BRIEF DESCRIPTION OF FIGURES

Having thus described the disclosure in general terms, references will now be made to the accompanying figures, wherein:

FIG. 1 illustrates samples coated with the marking composition: (a) before absorbing the light source; and (b) after absorbing the light source.

FIG. 2 illustrates a luminous sample when the ambient light surrounding the marking composition is below a pre-defined illumination.

FIG. 3 illustrates a luminous sample when the ambient light surrounding the marking composition is below a pre-defined illumination.

FIG. 4 illustrates a repeatable stability test done for about 26 charging and discharging cycles.

FIG. 5 illustrates a comparison of the light emission original test sample (left), and sample kept in water for over 24 h (right).

FIG. 6 illustrates a sample immersed in about 20% salt water for about 32 h.

FIG. 7 illustrates a flowchart representing a process for preparing a marking composition.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

Reference will now be made in more detail to embodiments, examples of which are illustrated in the accompanying drawings, wherein like reference numerals refer to like elements throughout the specification. In this regard, the present embodiments may have different forms and should not be construed as being limited to the descriptions set forth herein. Accordingly, the embodiments are merely described below, by referring to the figures, to explain aspects of embodiments of the present description. As used herein, the term ‘and/or’ includes any and all combinations of one or more of the associated listed items. Throughout the present disclosure, the expression ‘at least one of a, b and c’ indicates only a, only b, only c, both a and b, both a and c, both b and c, all of a, b, and c, or variations thereof.

The subject matter of the present application may include various modifications and various embodiments, and example embodiments will be illustrated in the drawings and described in more detail in the detailed description. Effects and features of the subject matter of the present disclosure, and implementation methods therefore will become clear with reference to the embodiments described herein below together with the drawings. The subject matter of the present application may, however, be embodied in many different forms and should not be construed as limited to the embodiments set forth herein.

Hereinafter, embodiments of the present application will be described in more detail with reference to the accompanying drawings. The same or corresponding elements will be denoted by the same reference numerals, and thus, redundant description thereof will not be repeated.

It will be understood that although the terms ‘first,’ ‘second,’ etc. may be used herein to describe various elements, these elements should not be limited by these terms. These terms are only used to distinguish one element from another.

An expression used in the singular may also encompass the expression of the plural unless it has a clearly different meaning in the context.

In the following embodiments, it is to be understood that terms such as ‘including,’ ‘includes,’ ‘having,’ ‘comprises,’ and ‘comprising,’ are intended to indicate the existence of the features or elements disclosed in the specification and are not intended to preclude the possibility that one or more other features or elements may exist or may be added.

In order to facilitate an understanding of the composition and/or article and/or product discussed herein, a number of terms are defined below. The terms defined below, as well as other terms used herein, should be construed to include the provided definitions, the ordinary and customary meaning of the terms, and any other implied meaning for the respective terms. Thus, the definitions below do not limit the meaning of these terms, but only provide exemplary definitions.

The present disclosure, in general, relates to the field of marking technology and particularly relates to a marking composition and preparation process thereof. Visibility markings are crucial for ensuring safety and enhancing navigation in both indoor and outdoor environments as described above.

For the purpose of instant disclosure and as is known to a skilled person in the art, the term ‘marking’ refers to, but is not limited to, a material, component, or composition presented as lines, patterns, and/or words used in indoor and/or outdoor environments to control, warn, guide, and inform through visibility. Further, as is known to a skilled person in the art, the term ‘composition’ pertains to, but is not limited to formulation, mixture, constitution, and/or blend, and may be applied in the form of at least one of paint, varnish, coating, finish, lacquer, enamel, sealant, pigment, dispersant, topcoat, primer, gloss, etc., on/in any material/substance conventionally perceivable to a person skilled in the art.

An aspect of the instant disclosure relates to a marking composition, comprising a phosphorescent component; a silica-based component; and a water-based medium, wherein the marking composition emits light when an ambient light surrounding the marking composition is below a pre-defined illumination, and wherein the emitted light is independent of a continuous external light source.

An embodiment of the instant disclosure relates to a marking composition.

As described previously, marking systems have relied on a combination of reflective materials, including cement, fluorescent pigments, silica, glass fibers, and acrylic polymer agents for visibility marking compositions.

However, one significant concern is that many of these compositions exhibit limited durability and inadequate long-term luminescence.

Thus, currently, phosphorescent components have emerged as viable alternatives to traditional luminescent and reflective materials, driven by their unique properties and advantages.

Now, as is known to a skilled person in the art, the term ‘phosphorescent’, or ‘phosphorescence’ pertains to a type of photoluminescence related to fluorescence. When exposed to light of a shorter wavelength, a phosphorescent component (phosphor) absorbs the energy and subsequently reemits it as a glow at a longer wavelength.

Unlike fluorescence, which stops emitting light almost immediately after the excitation source is removed, phosphorescence involves a delayed emission due to the transition of excited electrons to a longer-lived triplet state. It is thus advantageous over fluorescence-based component(s).

Consequently, the instant disclosure incorporates a phosphorescent component (phosphor), or a combination thereof with other components, tailored to specific needs, such as color or light retention time.

In an embodiment of the instant disclosure, the marking composition comprises a phosphorescent component.

For the purpose of instant disclosure and as is known to a skilled person in the art, the term ‘component’ or ‘components’ pertains to a chemically independent constituent of a system. The number of components represents the minimum number of independent species necessary to define the composition.

In a related embodiment, the phosphorescent component comprises a dopant. Now, for the purpose of instant disclosure and as is conventionally known to skilled person in the art, the term ‘dopant’ or ‘doped’ pertains to a small amount of a substance/component added to a material/composition to alter its physical properties.

In a related embodiment, the dopant is at least one rare-earth compound; preferably, at least one of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y); and particularly, at least one of europium (Eu), neodymium (Nd), or dysprosium (Dy).

In another related embodiment, the quantity of the dopant in the phosphorescent component ranges from 0.01 mol % to 10 mol %; preferably, the quantity of Eu ranges from 0.1-2 mol %; more preferably, the quantity of Nd ranges from 0.1-2 mol %; and particularly, the quantity of Dy ranges from 1-3 mol %.

In another related embodiment, the phosphorescent component is at least one of Alkaline earth aluminate-based and/or Alkaline earth silicate-based.

The instant disclosure may implement Alkaline earth aluminate and/or Alkaline earth silicate such as, but not limited to, MA12O4 (M=Mg, Ca, Sr), and/or M2MgSi2O7 (M=Mg, Ca, Sr).

In another related embodiment, the quantity of alkaline earth aluminates and/or silicates in the phosphorescent component ranges from 0.01% to 99.99%; preferably ranges from 50% to 99.99%; and particularly ranges from 95% to 97%. An embodiment of the instant disclosure relates to synthesizing a phosphorescent component.

In a related embodiment, the phosphorescent component is synthesized using a high-temperature solid-state reaction in specialized conditions; and preferably, using an electric muffle furnace.

In an exemplary embodiment, at least one dopant and at least one alkaline earth aluminate and/or alkaline earth silicate are mixed using conventionally known mixers to obtain a powdered mix. The powdered mix is placed in crucibles perceivable to a skilled person and kept inside a furnace; preferably, an electric muffle furnace. The atmosphere inside the furnace is reduced using conventionally known methods to obtain the phosphorescent component. Once the reaction is complete, the furnace is cooled to room temperature using perceivable methods, and the phosphorescent component obtained is ground to a fine powder using conventionally known methods to obtain a (powdered) phosphorescent component. In a related embodiment, the temperature for synthesizing a phosphorescent component ranges from about 1200 °C-1300 °C; preferably for more than 5 h. In another related embodiment, the phosphorescent component is sieved through a sieving machine perceivable to a skilled person in the art to achieve a specific particle size.

In yet another related embodiment, the particle size ranges from 30 microns to 50 microns.

In a further related embodiment, concentration of the phosphorescent component in the marking composition ranges from 0.01% to 50% of total marking composition; preferably, ranges from 10% to 55% of total marking composition; and particularly ranges from 20% to 40% of total marking composition.

For the purpose of instant disclosure and as is conventionally known to a skilled person in the art, the term ‘total marking composition’ pertains to the entirety of the composition; and preferably, the marking composition with respect to its constitution/formulation.

Another embodiment of the instant disclosure relates to surface-functionalizing/coating the phosphorescent component.

For the purpose of the instant disclosure and as is known to a skilled person in the art, the term ‘surface-functionalized’, ‘coat’, ‘coating’, ‘coated’, ‘surface-functionalize(s), or ‘surface-functionalization’ pertains to the act of modifying a surface to give it physical, chemical, or biological characteristics different from the ones originally possessed by it.

In a related embodiment, the phosphorescent component is coated by carrying out at least one of the physical and/or chemical treatments conventionally known to a skilled person in the art.

In another related embodiment, the phosphorescent component is coated by carrying out at least one of Physical vapor deposition (PVD), plasma surface treatment.

In a related embodiment, at least one of silica-based components perceivable to a person skilled in the art coats the phosphorescent component discussed above. It is known to a skilled person in the art that silica-based coating(s) protect the phosphorescent components from moisture damage by shielding them from both environmental oxidation and water erosion, ensuring long-term water stability.

A related embodiment of the instant disclosure relates to coating the phosphorescent component using a silica-based component; preferably using at least one solution-based method conventionally perceivable to a person skilled in the art; and particularly using the conventionally known sol-gel method/procedure.

In an exemplary embodiment, the phosphorescent component described above is coated with a thin layer of silica using the sol-gel procedure to obtain a coated phosphorescent component (additive).

In a related embodiment, the thin layer of silica is about 50 nm.

In another related embodiment, the coated phosphorescent component is obtained from sol-gel solutions of tera ortho ethyl silicate (TEOS); preferably treated at about 300 °C.

For instant disclosure, the term ‘coated phosphorescent component’ further pertains to an additive; wherein, the term ‘additive’, as is conventionally known to a person skilled in the art is a component that is added to a composition; preferably to improve its functioning.

Now, it is known that commercially available phosphor-based compositions often rely on organic solvents, which can emit undesirable vapors into the atmosphere and pose significant risks of soil and water contamination, particularly in areas adjacent to roadways. Additionally, sulphide-based phosphor compositions face considerable challenges, including chemical instability and limited effectiveness in outdoor environments; thereby complicating their practical use.

The instant disclosure aims to address these challenges by placing water-based alternatives.

Consequently, in an embodiment, the marking composition comprises a water-based medium.

Further, it is known that a transparent medium is preferred for road marking applications to minimize scattering losses.

Thus, in a related embodiment, the water-based medium is a transparent medium; preferably selected from at least one of lacquer, polyurethane resin, acrylic, emulsion, polycarbonate, methyl methacrylate, or polyethylene terephthalate.

In another related embodiment, the concentration of the water-based medium ranges from 20% to 90% of the total marking composition; preferably, ranges from 40% to 80% of the total marking composition; and particularly, ranges from 60% to 70% of the total marking composition previously described.

An embodiment of the instant disclosure relates to dispersing the coated phosphorescent component in a water-based medium described above; particularly, to obtain the marking composition.

For instant disclosure, ‘dispersing’ may be carried out using a conventionally known high-speed paint mixer/agitator.

As is perceivable to a person skilled in the art, the time and temperature may vary as per requirements.

Further, in an embodiment, ‘dispersing’ may be carried out using a dispersant. In a related embodiment, the dispersant is, but is not limited to Solsperse 39000, Triton X-100, Ceraplast 400, CERDISPER ZN 20, EFKA 4560, TEGO Dispers 740 W, DISPERBYK-190, or BYK-111 perceivable to a person skilled in the art.

It is known to a skilled person in the art that a dispersing agent/dispersant is a crucial component for achieving optimal performance in paints, coatings, and inks. It facilitates the creation of highly loaded, stable, and widely compatible dispersions across various combinations of solid particles. In ceramic formulations, producing dense material structures requires suspension with uniform particle distribution and high solid content, which is made possible by the right dispersant. Beyond enhancing mechanical strength, dispersants play a vital role in the coating process by ensuring proper wetting and dispersion of fine powders. They also aid in rheology control, reducing viscosity, and minimizing particle agglomeration, resulting in a more uniform particle size distribution.

An embodiment of the instant disclosure relates to the process for preparing a marking composition.

In an exemplary embodiment, the coated phosphorescent component (additive) previously described is homogenously dispersed using at least one dispersing agent described above in a water-based medium described above to obtain the marking composition.

In a related embodiment, the marking composition does not require any other additional fillers known to a skilled person.

It is conventionally known that the choice of medium depends on commercially available products used for surface protection on materials like concrete or wood, ensuring resistance to weathering.

In an embodiment, the marking composition eliminates the need for an additional overcoat; preferably, by minimizing flaking caused by vehicle tires.

Thus, eliminating dependency on commercially available products used for surface protection.

In an embodiment, the marking composition emits light when an ambient light surrounding the marking composition is below a pre-defined illumination.

For the purpose of the instant disclosure and as is conventionally known to a skilled person in the art, the term ‘emits’, ‘emission’, ‘emitted’, or ‘emit’ pertains to producing and releasing light, through a chemical or physical processing with respect to the phosphorescence phenomenon described above.

Further, the term ‘ambient light’ pertains to general lighting, dominating the lighting landscape of each room.

Additionally, the term ‘pre-defined’ pertains to established or limited in advance. Now, as is known to a skilled person in the art, the term ‘lux’ is the International System of Units (SI) unit of illumination, or luminous flux/unit area.

In an embodiment, the pre-defined illumination is below 300 lux; preferably, below 100 lux; and particularly, below 10 lux.

In a related embodiment, the marking composition emits light when the ambient light surrounding the marking composition is below the pre-defined illumination described above, for at least 8 h, 10 h, 12 h, 24 h, and 48 h.

In an exemplary embodiment, the aluminate-based phosphorescent components (doped with divalent rare earth elements) can emit light for about 12 h, while alkaline earth silicate-based phosphorescent components (doped with divalent rare earth elements) can emit light for over 40 h.

Now, it is known that visibility of emitted light is of paramount importance in both, external as well as internal environments as described above.

In an embodiment, the emitted light has a visibility of about 200 mcd/m2 in the first 30 mins.

In a related embodiment, the emitted light has a visibility of about 0.6 mcd/m2 under normal weather conditions.

In another related embodiment, the emitted light has a visibility of about 13 mcd/m2 during rainy conditions.

In yet another embodiment, the emitted light has a visibility of about 4 mcd/m2 under foggy conditions.

In an embodiment, the emitted light has a visibility that may be approximately double the minimum detection limit of the human eye.

In another embodiment, the marking composition emits light when an ambient light surrounding the marking composition is below a pre-defined illumination; preferably, with a visibility of about 90 m or above.

As is known to a skilled person in the art, the subject visibility is three times more than that provided by the conventionally known visibility marking compositions.

For the purpose of instant disclosure and as is conventionally known to a skilled person in the art, the term ‘normal weather conditions’ or ‘normal weather condition’ pertains to when the weather conditions are at or near the average climatological value for the given date at the specific geographical place/location. Further, the term ‘rainy conditions’ is defined by a combination of precipitation factors. ‘Rainy condition’ or ‘rainy conditions’ is, Light rain-when the precipitation rate is <2.5 mm (0.098 in)/h. Moderate rain-when the precipitation rate is between 2.5-7.6 mm (0.098-0.299 in) or 10 mm (0.39 in)/h. Heavy rain-when the precipitation rate is >7.6 mm (0.30 in)/h, or between 10 and 50 mm (0.39 and 1.97 in)/h.

In an embodiment, the rainy conditions relate to the precipitation rate of 50 mm≥2.5 mm.

In addition to this, the term ‘foggy conditions’ or ‘foggy condition’ pertains to when a cloud of small water droplets that is near ground level is observed, which is sufficiently dense to reduce horizontal visibility to less than 1,000 meters (3,281 feet).

In an embodiment, the marking composition may absorb sunlight during the day, store energy for extended periods; and preferably, emit light; and particularly, green light at night through phosphorescence.

As is known to a skilled person in the art, the duration of light emission of the composition may be influenced by various factors, including phosphor particle size, shape, porosity, scattering, and paint transparency.

Now, as is known to a skilled person in the art, a larger particle size has less surface defect and may emit more light.

Consequently, in an embodiment, the phosphorescent component discussed above may have a larger particle size; ranging from 0.01 microns to 99.99 microns; preferably ranging from 20 microns to 70 microns; and particularly ranging from 30 microns to 50 microns.

Further, as is known to a skilled person in the art, spherical components are feasible for uniform scattering. Thus, preferably, with respect to paint dispersion, spherical-shaped phosphor particles may be implemented.

As is known to a skilled person in the art, porous material can induce more scattering of the emitted fluorescent light; and preferably, using suitable synthesis conditions and chemical process perceivable to a skilled person in the art, 20-30% porosity can be further improved to enhance the light output.

Consequently, in an embodiment, the phosphorescent component discussed above may be porous.

It is known to a skilled person in the art that the transparency of the paint medium is the most important factor as an opaque medium will not transmit the emitted light.

Consequently, the additive and/or the phosphorescent component discussed above is not incorporated in an opaque paint.

In an embodiment, the emitted light is independent of a continuous external light source.

For the purpose of instant disclosure and as perceivable to a person skilled in the art, the term ‘continuous external light source’ pertains to streetlights or vehicle headlights. Thus, the requirement of energy (as in the case of traditional retroreflecting glass bead technology) is minimized in the present case, providing energy efficiency. Furthermore, since the requirement of streetlights and vehicle headlights is eliminated, the marking composition can be applied in urban as well as rural locations.

In a related embodiment, the marking composition works well when an ambient light surrounding the marking composition is below a pre-defined illumination; preferably, in the absence of any continuous external light source discussed above.

In an exemplary embodiment, the marking composition described above is applied; preferably as a topcoat; and particularly on any material/substance to form a coating.

In a related embodiment, the marking composition is applied in thickness ranging from about 0.1 to 1.0 mm; and preferably from about 0.3 to 0.5 mm.

In another embodiment, the marking composition is applied to an existing white road marking (a sample) as a coat/topcoat/coating.

In an embodiment, the marking composition (comprising the additive) imparts minimum luminous intensity.

For determining luminous intensity, in a related embodiment, a brightness test and/or a visual observation may be performed on the sample described above using conventionally known methods.

In another embodiment, the marking composition (comprising the additive) meets visibility requirements.

For determining visibility requirement(s), the sample may be exposed to a 150 W xenon lamp for about 5 mins, and photometer data may be recorded over time. For the purpose of instant disclosure and as is perceivable to a person skilled in the art, the visibility requirement is about 6.3mcd/m2 .

In a related embodiment, the afterglow brightness of the sample after 12 h is about 6.3mcd/m2.

In an embodiment, the marking composition (comprising the additive) meets basic adhesion requirements.

For the purpose of the instant disclosure, the adhesion requirements are determined using conventionally practiced ASTM test(s).

In a related embodiment, the bond strength of the coating with asphalt and concrete pavement is about 0.79 and 0.98 MPa, respectively, meeting the basic adhesion requirements.

In another embodiment, the marking composition (comprising the additive) is abrasion resistant.

In an exemplary embodiment, to determine abrasion resistance, conventional ASTM standard methods/tests are implemented such as, but not limited to wearing the coating (marking composition) and calculating the mass before and after.

In an embodiment, the abrasion of the coating is about 63.8 mg, which is conventionally known to be within acceptable limits.

In a further embodiment, the marking composition (comprising the additive) is weather resistant.

It is perceivable to a person skilled in the art that weather resistance may be determined via conventionally known procedures/tests such as, but not limited to determining water resistance, repeatable luminescence stability, and/or determining saltwater resistance.

In an exemplary embodiment, to determine the water resistance of the coating, the sample is immersed in room temperature water for about 24 h to evaluate the effect on the paint film's properties.

In a related embodiment, the marking composition comprising the additive imparts water resistance.

In another related embodiment, the long afterglow of the marking composition comprising the additive exhibits excellent resistance to reversible fatigue during the cycle of exposure to UV and visible light (conventionally perceivable to a skilled person in the art).

In a further related embodiment, the marking composition comprising the additive imparts resistance to salt water.

In another exemplary embodiment, to determine the long-term weather resistance of the marking composition (comprising the additive), the sample is subjected to rain for about 6 months and examined for light output during that period.

In a related embodiment, observations show that water does not affect the glow performance of the marking composition (comprising the additive).

Another aspect of the instant disclosure relates to a process for preparing a marking composition, comprising synthesizing a phosphorescent component (701); coating the phosphorescent component using a silica-based component to obtain a coated phosphorescent component (703); and dispersing the coated phosphorescent component in a water-based medium to obtain the marking composition (705), wherein the marking composition emits light when an ambient light surrounding the marking composition is below a pre-defined illumination, and wherein the emitted light is independent of a continuous external light source.

An embodiment relates to a process for preparing a marking composition described above.

Another embodiment relates to synthesizing a phosphorescent component described above.

In a related embodiment, the phosphorescent component is synthesized using a high-temperature solid-state reaction in the specialized conditions described above. In another related embodiment the phosphorescent component comprises a dopant as described above; preferably selected from at least one rare-earth compound described above; and particularly selected from at least one of europium (Eu), neodymium (Nd), or dysprosium (Dy).

In a further related embodiment, the phosphorescent component is either alkaline earth-aluminate or alkaline earth-silicate based, as described above.

In yet another further related embodiment, concentration of the phosphorescent component ranges from 20% to 40% of total marking composition described above.

A further embodiment relates to coating the phosphorescent component, as described above; preferably, using a silica-based component described above; and particularly, to obtain a coated phosphorescent component (additive) described above.

Yet another further embodiment relates to dispersing the coated phosphorescent component in a water-based medium described above; preferably, to obtain the marking composition.

In a related embodiment, the water-based medium is a transparent medium described above; preferably, selected from lacquer, polyurethane resin, acrylic, or emulsion.

In another related embodiment, concentration of the water-based medium ranges from 60% to 70% of total marking composition described above.

In an embodiment, the process for preparing the marking composition may be at least one of manual, mechanical, automated, semi-automated, batch. Continuous, large-scape, and/or small scale as per requirements.

In a related embodiment, the marking composition may be applied using conventional roadway painting equipment; preferably by modifying nozzle and container as per requirement (and as is conventionally perceivable to a skilled person in the art).

As is perceivable to a person skilled in the art and as per requirement(s), the marking composition may be manually, or machine-applied; wherein, preferably, the machines can be either manually operated or mounted on trucks for continuous application, often in conjunction with reflective materials like glass beads for skip-line and continuous markings.

In a related embodiment, the marking composition is applied when the surface temperature (during application) is at least 10 °C.

For the purpose of instant disclosure and as is perceivable to a person skilled in the art, the term ‘surface’ pertains to the layer of interest of any material that is supposed to be coated with the composition.

The marking composition can be applied in numerous fields for outdoor as well as indoor environment marking, such as, but not limited to transportation, aerospace, maritime, construction, industrial, emergency services, sports and recreation, healthcare, retail, and public spaces, military wherein improved safety, navigation, and communication may be pertinent.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated but is to be accorded the widest scope consistent with the principles and features described herein.

The foregoing description shall be interpreted as illustrative and not in any limiting sense. A person of ordinary skill in the art would understand that certain modifications could come within the scope of this disclosure. The features and properties of the present disclosure are described in further detail below with reference to examples.

### EXAMPLE 1

### A Process for Preparing a Coated Phosphorescent Component (Additive)

### Synthesizing a Phosphorescent Component (701)

For the present disclosure, the phosphorescent component was synthesized using a high-temperature solid-state reaction in specialized conditions. Stoichiometrically calculated chemical components were mixed well using a powder mixer to obtain a powdered mix, wherein the mixing time was determined by the quantity of materials. As is perceivable to a person skilled in the art, larger quantities required several hours of mixing for homogeneity.

The powdered mix obtained was then placed in alumina crucibles and kept inside the electric muffle furnace.

To create a reducing atmosphere inside the furnace, either vacuum air was pulled out using a rotary pump, or the furnace was filled with inert gas such as, but not limited to argon (or by using carbon powder). The reaction time and temperature were determined by the quantity of materials inside the furnace. Preferably, the temperature ranges from about 1200 °C-1300 °C for about more than 5 h. Once the reaction was complete the furnace was cooled down to room temperature and the product was taken out and ground to a fine powder to get the product ((powdered) phosphorescent component). To achieve specific particle sizes, the product was sieved through an appropriate sieving machine perceivable to a skilled person in the art.

The particle size implemented for the instant disclosure ranged from 30 microns to 50 microns.

The phosphorescent component cannot be used directly for making the marking paint as the powder can be hydrolyzed in rainy conditions. Consequently, the phosphorescent component was coated in order to prevent the hydrolysis of the powdered phosphorescent component.

### Coating the Phosphorescent Component Using a Silica-Based Component to Obtain a Coated Phosphorescent Component (703)

The phosphorescent component was coated with a thin layer (about 50 nm thick) of silica using a sol-gel procedure, conventionally perceivable to a skilled person in the art to obtain a coated phosphorescent component (additive).

For the purpose of the instant disclosure, the coated phosphorescent component was obtained from sol-gel solutions of tera ortho ethyl silicate (TEOS) treated at about 300 °C.

### EXAMPLE 2

### A Process for Preparing a Marking Composition

### Dispersing the Coated Phosphorescent Component in a Water-Based Medium to Obtain the Marking Composition: (705)

The coated phosphorescent component (additive) synthesized above was homogeneously dispersed in about 700 ml of lacquer without any other additional fillers. Then about 100 ml Solsperse was used as a dispersing agent to prevent particles from settling in the lacquer to obtain the marking composition.

The marking composition obtained was applied as a topcoat/coat/coating to an existing white road marking in thickness ranging from about 0.3 to 0.5 mm (sample), and its performance was analyzed.

The optimum thickness was confirmed by the applicator based on the night performance needed. A very thick layer was not needed as the light emission properties depend on the fluorescence from the top layer only.

Performance Analysis of the sample (top-coated with the marking composition comprising the additive):
a) Brightness test:

Visual Observation: After exposure to sunlight for about 15 mins, the sample was placed below a pre-defined illumination (less than 100 lux) from 6 pm to 6 am, and digital photos were taken at different time intervals.

Test results:

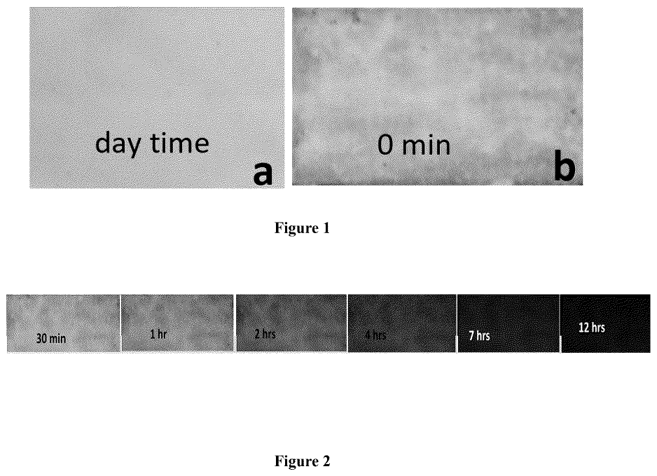

As seen in FIGS. 1 and 2, the sample showed exceptional brightness for the first hour, with stable luminescence visible for up to 4 h. After 4 h, the luminescence remained stable up to 6 am, exceeding the minimum required luminous intensity. Thus, it was deduced that the marking composition comprising the additive imparts minimum luminous intensity.

Photometer Measurement: The sample was exposed to a 150 W xenon lamp for about 5 mins, and photometer data were recorded over time.

Test results:

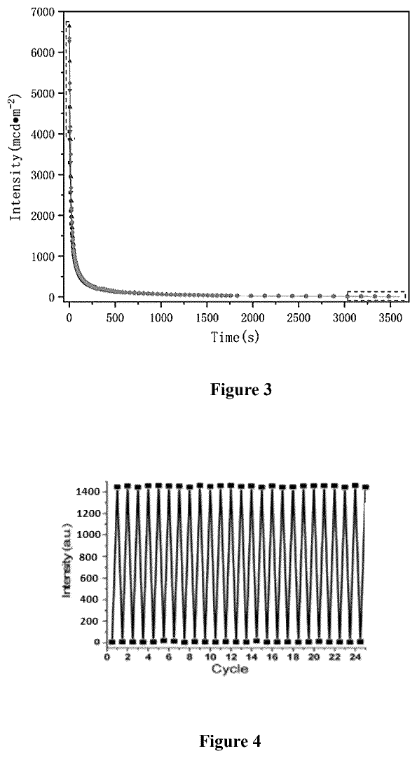

FIG. 3 illustrates a luminous sample when the ambient light surrounding the marking composition is below a pre-defined illumination and determines that the afterglow brightness of the sample after 12 h was about 6.3mcd/m2 , meeting visibility requirements.
b) Abrasion resistance:

The sample was worn about 200 times with a rubber grinding wheel with a weight of 1,000 g, and the mass before and after wearing was calculated to find the mass loss.

Test results:

The abrasion of the subject coatings was about 63.8 mg, which is conventionally known to be within acceptable limits.
c) Bond Strength by the Pull Test

The bond strength between coating and pavement was tested by a DeFelsko portable adhesion tester according to ASTM D4541, ‘Standard Test Method for Pull-Off Strength of Coatings Using Portable Adhesion Testers.’ The pull-out sample was attached to the cured coating surface by epoxy resin, and the bond strength between the sample and asphalt/concrete pavement was measured.

Test results:

The bond strength of the coating with asphalt and concrete pavement was 0.79 and 0.98 MPa, respectively, meeting the basic adhesion requirements.
d) Water resistance test

The Sample was immersed in room temperature water for about 24 h to evaluate the effect on the paint film's properties.

Test results:

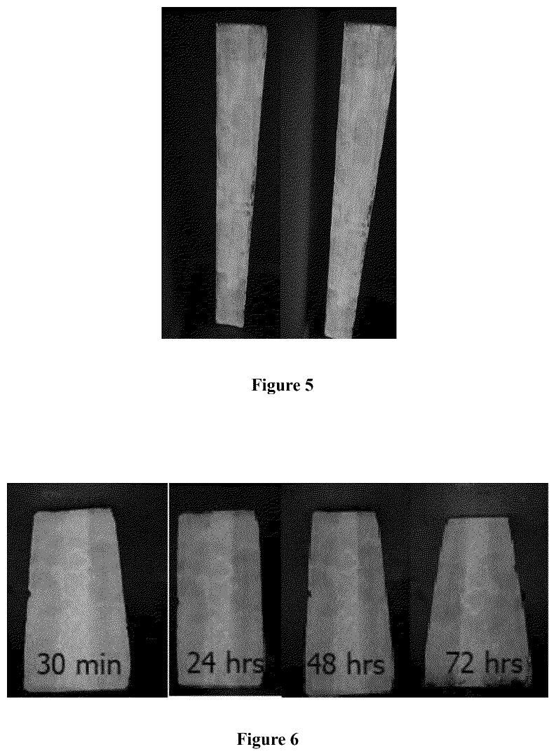

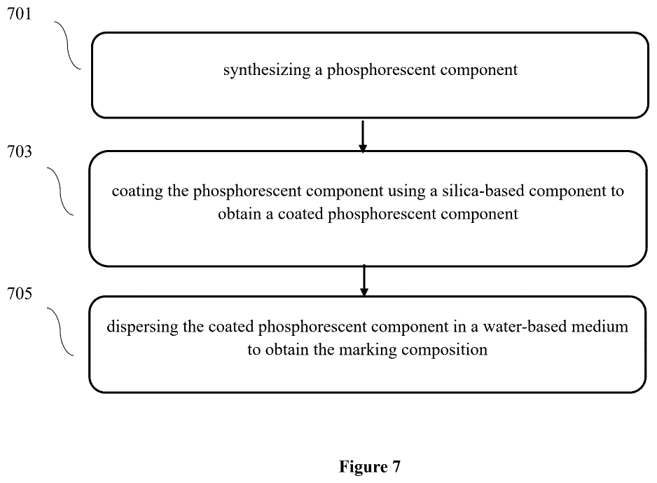

FIG. 5 is a photo (taken after 40 days) of a water-immersed sample (water immersed for about 24 h) and a non-immersed sample, which shows that no significant changes in the exterior of the coated sample/properties of the coated sample was observed after 24 h of immersion, thereby deducing that the marking composition comprising the additive imparts water resistance.

Additional analysis:

Repeatable Luminescence Stability: The repeatable luminescence stability refers to the ability of the material to maintain phospholuminiscence properties under frequent excitation-emission cycles. The photoluminescence is weakened, and the luminous time is shortened during the cycles. Therefore, repeatable stability is a key parameter.

Test results:

FIG. 4 demonstrates that the long afterglow (by the sample) exhibited excellent resistance to reversible fatigue during the cycle of exposure to UV and visible light (after about 26 charging and discharging cycles).

Saltwater test: The sample was immersed in 20% salt water for about 32 h and observed for light performance.

Test results:

FIG. 6. shows no appreciable change in the light emission properties even after 72 h, thereby deducing that the marking composition comprising the additive imparts resistance to salt water.

As per the foregoing experimental analysis, the additive and the marking composition comprising thereof demonstrate the following:
Exceptional luminous performance, meeting or exceeding required visibility standards.
Robust repeatable luminescence stability under frequent excitation-emission cycles.
Strong adhesion to both asphalt and concrete pavement surfaces.
Excellent abrasion resistance, ensuring long-lasting road markings.
Outstanding water as well as saltwater resistance, with no significant impact on the paint film's/coating's properties.

The additive and the marking composition comprising thereof achieve the following technicalities:

Light Emission: preferably, green light for an extended period, up to 12 h, after absorbing ambient or solar light during the daytime.

Blend Compatibility: seamless blending into various transparent paints/medium, particularly thermoplastic paint, lacquer, acrylic, polyurethane, and emulsion, at varying weight percentages.

Weather Resistance: Exceptional weather resistance, with no degradation observed under rainy conditions, high temperatures, or low temperatures.

Abrasion Resistance: Significantly higher abrasion resistance when compared to retroreflecting glass beads, ensuring long-lasting road markings.

Visibility: Within the first 30 min it provides a visibility close to 200 mcd/m2. The additive then imparts the composition with a minimum brightness of 0.6 mcd/m2 under normal weather conditions, 4 mcd/m2 under foggy conditions, and an impressive 13 mcd/m2 during rainy conditions. This offers visibility approximately double the minimum detection limit of the human eye, when an ambient light surrounding the marking composition is below a pre-defined illumination.

No Continuous Light Exposure Required: Unlike traditional markings, the additive imparts the advantage to the composition of eliminating the need for continuous external light sources such as streetlights or vehicle headlights for visibility, enhancing road safety and energy efficiency.

It is noted that in the absence of both streetlight and headlight, the conventionally implemented white line was completely invisible while the new road marking (incorporating the marking composition) was still visible with a brightness of about 0.6 cd/m2. The brightness was noted to be 1.64 times that of general white paint after seven days.

The additive and the marking composition comprising thereof have the following environmental impact:
1. Reduces the need for street lighting in rural areas, lowering CO2 emissions.
2. Luminescent paint absorbs more sunlight than traditional white paint, helping to combat the urban heat island effect.
3. Element concentrations meet EPA standards for soil and water cleanliness.
4. Sustainable replacement to retroreflective glass beads that can release heavy metals like lead, cadmium, and arsenic into the environment.

It is known that use of glass beads has led to arsenic exceeding 3 μg/L, lead exceeding 65 μg/L, and antimony exceeding 78 μg/L.6. Glass beads are used at 72% concentration of total marking composition, higher than the 20-40% range of current technology.

The additive and marking composition comprising thereof have the following economic impact:

Energy-saving technology;

Retroreflective glass sphere technology (50 mcd/m2) reduces accident rates by 18%; Increasing marking brightness by 1.75 times cuts traffic accidents by about 42%; Current technology boosts brightness by over 1.5 times;

Technology is more effective than existing methods for reducing traffic accidents; and

Economically feasibility for accident-prone roads with low lighting.

While one or more embodiments have been described with reference to the figures, it will be understood by those of ordinary skill in the art that various changes in form and details may be made therein without departing from the scope of the present application as defined by the following claims, and equivalents thereof.

We claim:

1. A marking composition,
the marking composition comprises:
a phosphorescent component;
a silica-based component; and
a water-based medium,
wherein the marking composition emits light when an ambient light surrounding the marking composition is below a pre-defined illumination, and
wherein the emitted light is independent of a continuous external light source.

2. The marking composition as claimed in claim 1, wherein the phosphorescent component comprises a dopant selected from at least one rare-earth compound europium (Eu), neodymium (Nd), or dysprosium (Dy).

3. The marking composition as claimed in claim 1, wherein the phosphorescent component is either alkaline earth-aluminate or alkaline earth-silicate based.

4. The marking composition as claimed in claim 1, wherein concentration of the phosphorescent component ranges from 20% to 40% of total marking composition.

5. The marking composition as claimed in claim 1, wherein particle size of the phosphorescent component ranges from 30 microns to 50 microns.

6. The marking composition as claimed in claim 1, wherein the silica-based component coats the phosphorescent component with a thin layer.

7. The marking composition as claimed in claim 6, wherein the thin layer is about 50 mm.

8. The marking composition as claimed in claim 1, wherein the water-based medium is a transparent medium selected from lacquer, polyurethane resin, acrylic, or emulsion.

9. The marking composition as claimed in claim 1, wherein concentration of the water-based medium ranges from 60% to 70% of total marking composition.

10. The marking composition as claimed in claim 1, wherein the marking composition emits light when the ambient light surrounding the marking composition is below the pre-defined illumination for at least 12 h.

11. The marking composition as claimed in claim 1, wherein the emitted light has a visibility of about 200 mcd/m2 in first 30 mins, about 0.6 mcd/m2 under normal weather conditions, about 13 mcd/m2 during rainy conditions, and about 4 mcd/m2 under foggy conditions.

12. The marking composition as claimed in claim 1, wherein the marking composition is at least one of weather resistant and abrasion resistant.

13. The marking composition as claimed in claim 1, wherein the marking composition optionally comprises a filler.

14. A process for preparing a marking composition, the process comprising:
synthesizing a phosphorescent component;
coating the phosphorescent component using a silica-based component to obtain a coated phosphorescent component; and
dispersing the coated phosphorescent component in a water-based medium to obtain the marking composition,
wherein the marking composition emits light when an ambient light surrounding the marking composition is below a pre-defined illumination, and
wherein the emitted light is independent of a continuous external light source.

15. The process as claimed in claim 14, wherein the phosphorescent component is synthesized using a high-temperature solid-state reaction in specialized conditions.

16. The process as claimed in claim 14, wherein the phosphorescent component comprises a dopant selected from at least one rare-earth compound europium (Eu), neodymium (Nd), or dysprosium (Dy).

17. The process as claimed in claim 14, wherein the phosphorescent component is either alkaline earth-aluminate or alkaline earth-silicate based.

18. The process as claimed in claim 14, wherein concentration of the phosphorescent component ranges from 20% to 40% of total marking composition.

19. The process as claimed in claim 14, wherein the water-based medium is a transparent medium selected from lacquer, polyurethane resin, acrylic, or emulsion.

20. The process as claimed in claim 14, wherein concentration of the water-based medium ranges from 60% to 70% of total marking composition.
